(19) United States
(12) Patent Application Publication
(10) Pub. No.: US 2008/0201178 A1
(43) Pub. Date: Aug. 21, 2008

(54) ON-DEMAND TRAVEL MANAGEMENT SERVICE AND PLATFORM

(76) Inventor: Yuri Vizitei, Columbia, MO (US)

Correspondence Address: HOLLAND & KNIGHT LLP, 10 ST. JAMES AVENUE, 11th Floor, BOSTON, MA, 02116-3889, US

(21) Appl. No.: 11/774,080

(22) Filed: Jul. 6, 2007

Related U.S. Application Data
(60) Provisional application No. 60/890,830, filed on Feb. 20, 2007.

(51) Int. Cl. G06Q 10/00

(52) U.S. Cl. 705/5

(57) ABSTRACT

The present invention contemplates an easy-to-use, cost-efficient, and flexible travel booking service and travel management platform. The travel booking service is a unique, subscription-based service that offers subscribers access to the fullest extent of travel service suppliers and also the lowest possible price. The travel management platform allows users to complete all steps of searching for and booking travel arrangements through the convenience of email. Once booked, travel arrangements are automatically calendared into the user's calendar. Optional plug-ins allow the user to filter search results based on existing calendar commitments, receive notifications when new calendar entries conflict with travel arrangements, and make travel arrangements directly through the user's calendar application rather than email.

### RELATED APPLICATION(S)

This application claims the benefit of U.S. Provisional Patent Application Ser. No. 60/890,830, filed 20 Feb. 2007, entitled “On-Demand Travel Arrangement Service and Platform”, the contents of which are herein incorporated by reference.

### FIELD OF THE INVENTION

The present invention relates to the field of travel booking services and tools, and more specifically to an on-demand travel booking service and travel management platform which offers to business and leisure travelers a comprehensive set of tools to manage all aspects of their travel needs, and to businesses a cost-efficient way to manage all travel.

### DESCRIPTION OF THE RELATED ART

Businesses may elect to arrange travel for their employees through managed travel services (e.g., Carlson Wagonlit Travel, Navigant International, American Express). These services negotiate special rates for companies and will enforce the travel policies of a company when booking travel. For instance, a corporate travel policy may specify which employees are permitted to fly in business or first class, and whether employees may fly business or first class on international flights. The main drawback of managed travel services is that fewer than half of all business travelers actually utilize their company's managed travel service to book their travel, due to the poor user experience and limited booking capabilities of many managed travel services. This has left many companies at a significant product cost and flexibility disadvantage.

Other businesses opt for an unmanaged travel system where individual employees arrange their own travel through various booking methods, including travel agents, assistants, internet-based travel websites (e.g., Expedia.com, Travelocity.com, Orbitz.com), and meta-search engines. Leisure travelers also utilize these conventional methods of unmanaged travel. However, with respect to businesses, none of these methods allow a company to take advantage of special negotiated corporate rates or enforce its corporate travel policies. Unmanaged travel therefore leaves companies at a significant operating cost disadvantage in comparison to companies using managed travel services.

Several drawbacks exist with respect to travel websites specifically. Travelers are overburdened with far too many choices, which are not filtered to suit the traveler's individual preferences or needs, or a company's corporate travel policies. Additionally, with the plethora of online travel websites that currently exist, travelers must expend significant amounts of time searching for the best possible itinerary at each website, and further must be able to recall specific log-in and password information associated their user account for each website. Finally, travel websites require employees to exit from their normal work flow, which for the vast majority of business employees, consists of reviewing and responding to emails. Employees must leave this framework and open up a separate internet application in order to book their travel.

### SUMMARY OF THE INVENTION

The present invention contemplates a variety of improved methods and systems for comprehensive travel management, with the benefits of both traditional managed and unmanaged travel systems. The present invention enables users to conveniently request, book, and calendar their travel arrangements in real-time through only email communication with a travel booking service. A user can send search queries for travel arrangements to the travel management platform via email. The travel management platform will search for and provide the user with a results email containing travel options based on the user's search query. The user may then book travel by sending a book request via email. Upon booking, the full itinerary will be emailed to the user and also automatically entered in the user's calendar.

According to one embodiment of the present invention, a user may also book travel arrangements using a mobile device.

In another embodiment, the user's query email can be in a natural language format. In another embodiment, the user's query email can be based on a form into which the user enters search terms, rather than natural language.

In yet another embodiment, prior to allowing a user to book his desired travel arrangements, the travel management platform will contact the user's manager for approval or denial of the requested travel. In this way, the manager may confirm that the user's travel arrangements coincide with any corporate travel rules or policies.

In yet another embodiment, which may achieved by installation of an optional plug-in to a user's specific email application, the user's other calendar commitments can be taken into consideration when searching for itinerary options, such that the user will not be offered travel options that conflict with his current calendar engagements. For example, if a user needed to fly from San Francisco to Los Angeles on a certain day, but could only depart after a noon meeting, flights prior to noon would be screened out and would not be presented to the user.

In yet another embodiment, a user may rearrange events within his calendar, and if any of these changes affect or conflict with the user's confirmed travel arrangements, the user will automatically be notified that changes need to be made to his itinerary. This functionality may again be achieved through installation of an optional plug-in specific to the user's particular email application.

In yet another embodiment, added efficiency may be achieved by enabling a user to book his travel arrangements through entering events and travel needs for that event (e.g., hotel, hotel and car, etc.) directly into his calendar. The user will subsequently receive an email listing possible travel arrangements for the event, exactly as he would have if he submitted a search query via email. Again, this functionality may be achieved through installation of an optional plug-in specific to the user's email application.

The optional plug-ins described above thus achieve an advantage over prior art in automating certain functions and managing a user's travel itinerary in coordination with his other scheduled calendar engagements.

### BRIEF DESCRIPTION OF THE DRAWINGS

These and other objects, features, and characteristics of the present invention will become more apparent to those skilled in the art from a study of the following detailed description in conjunction with the appended claims and drawings, all of which form a part of this specification. In the drawings:

FIG. 1 is a flow diagram representing the travel management platform of the present invention.

FIG. 2 is a flow diagram illustrating the general flow of searching for travel options in accordance with the present invention.

FIG. 3 is a flow diagram illustrating the general flow of booking travel arrangements in accordance with the present invention.

### DETAILED DESCRIPTION OF THE INVENTION

The present invention is a travel management platform through which travelers can book all of their travel needs through their current email service provider. The general process for utilizing the travel management platform to book travel is described below.

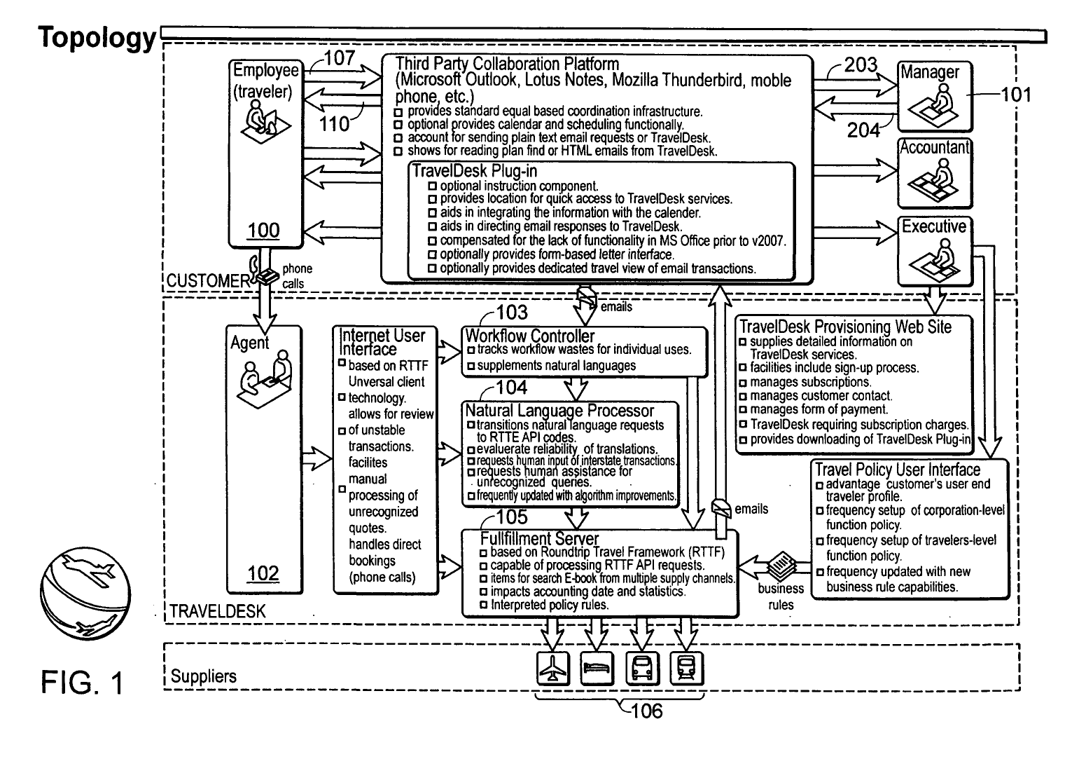

As depicted in FIG. 1, when travel arrangements need to be made, a user 100 sends a query email 107 containing a search query in natural language format to a workflow controller 103. For example, the user 100 may be an employee of a company that subscribes to the on-demand travel platform described herein. The search query could be a natural language query reading, “Going to Los Angeles, leaving June 18, returning June 20, need a hotel and a car.” The query email 107 could be based on a form into which the user 100 enters search terms, rather than natural language. Once the query email 107 has been sent, the user 100 can resume his normal work flow and need not remain engaged in the searching process. While the user 100 works and goes on with his or her business, his query email 107 is being processed and choices are filtered according to his personal travel profile and his company's corporate travel policy. In this way, the present invention frees the user's 100 time and achieves an advantage over the prior art, in that the user 100 need not remain on the telephone or the internet while a travel agent or search engine retrieves itinerary options.

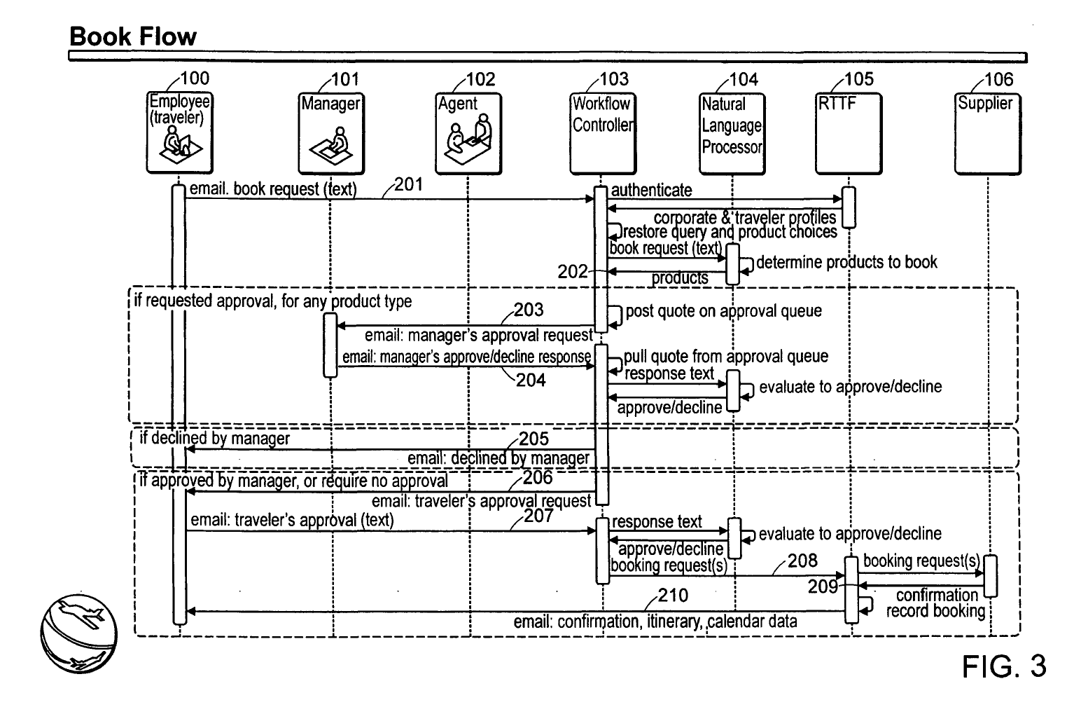

The workflow controller 103 authenticates the user 100 against a robust middleware software program 105, such as Roundtrip Travel Framework (RTTF), developed by Roundtrip Systems (RTS) and shown in FIG. 3. The middleware software 105 forms the core engine which interfaces with travel service suppliers 106 such as airlines and hotels. The middleware software 105 processes the information relating to availability, price, etc. from multiple travel service suppliers 106 and makes the information usable by other components of the travel management platform. The middleware software 105 thus ensures a seamless, unified flow of content-rich data from multiple travel service suppliers 106.

After the middleware software 105 receives user authentication from the workflow controller 103, the middleware software 105 responds to the workflow controller 103 with the user's 100 travel profile and corporate travel policies. The workflow controller 103 then sends the search query from the user's query email 107 to a natural language processor 104, which interprets the text and translates it into a structured API search query 108. This API search query 108 is returned to the workflow controller 103, which bounces the API search query 108 to the middleware software 105. The middleware software 105 interfaces with airlines, hotels, and other travel service suppliers 106 to fetch itinerary options, which get filtered based on the traveler profile and corporate travel policies. The filtered results 109 are then returned to the workflow controller 103. The workflow controller 103 then sends the API search query 108 and results 109 to an agent 102 for review and confirmation. Once the workflow controller 103 receives confirmation from the agent 102, it sends a results email 110 with a list of itinerary options to the traveler 100.

As the user 100 receives the results email 110 with itinerary options in his email inbox while he is working on other tasks, he may review the results email 110 upon receipt or at his leisure. Thus, the present invention achieves an advantage over the prior art. If booking travel through an online travel website, for example, a session timeout will occur within minutes and a traveler will have to restart his entire search again if he does not select an itinerary and continue all the way through booking all at once. Additionally, if booking through a travel agent, it is not possible to put the travel agent on hold until a later time in the day when it becomes more convenient to decide between possible itinerary options.

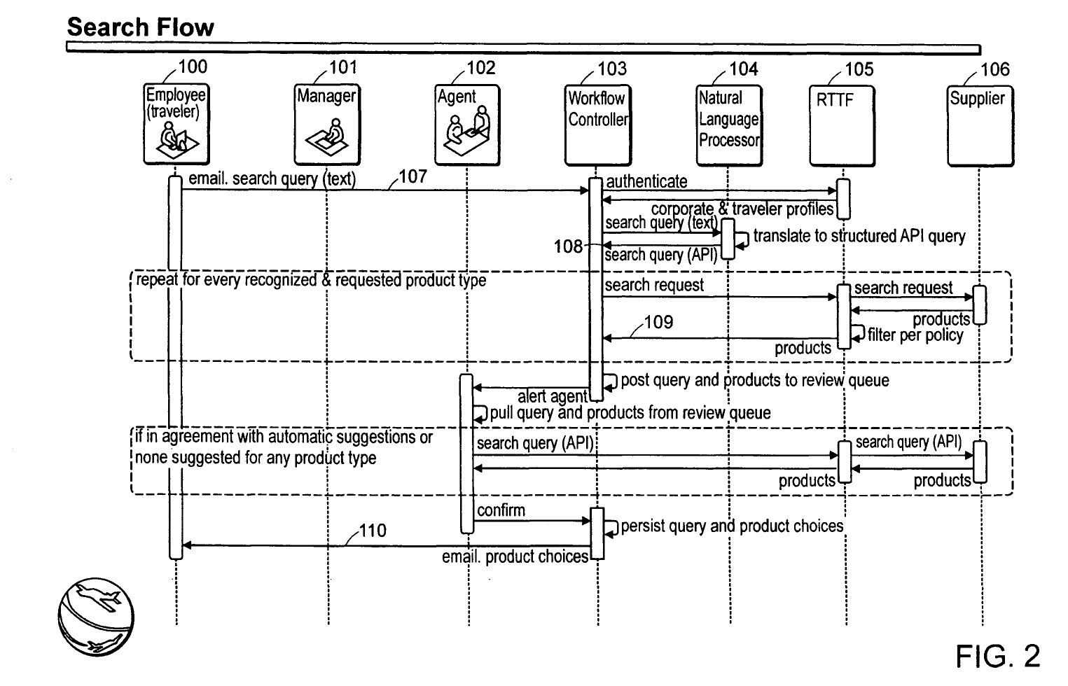

As depicted in FIG. 2, once the user 100 has selected a particular itinerary from the results email 110, he can then book his travel. The user 100 does so by replying to the results email 110 with a book request 201 in natural language to the workflow controller 103. The workflow controller 103 again authenticates the user against the middleware software 105, which again responds to the workflow controller 103 with the user's 100 travel profile and corporate travel policies. The workflow controller 103 then sends the book request 201 to the natural language processor 104, which interprets the text to determine which flight, hotel, or other travel product 202 the user 100 specified to book. The natural language processor 104 sends the travel product(s) 202 back to the workflow controller 103. If approval by the user's 100 manager 101 is required, the workflow controller 103 then sends the user's 100 manager 101 an email approval request 203. The manager 101 can send a response email 204 back to the workflow controller 103 in natural language format either approving or declining the email approval request 203. The workflow controller then sends the text from the response email 204 to the natural language processor 104, which interprets the text to determine whether the user's 100 travel has been approved or declined. The natural language processor 104 sends back to the workflow controller 103 the result of its determination.

If travel is declined by the user's 100 manager 101, the workflow controller 103 sends the user 100 an email 205 stating that his travel request has been declined.

If the user's 100 request is approved by the user's 100 manager 101, the workflow controller 103 sends an email approval request 206 to the user 100. In the case where approval by the user's 100 manager 101 is not required in the first place, the workflow controller 103 sends the email approval request 206 to the user 100 directly after receiving the travel products 202 from the natural language processor 104. The user can then send an email approval 207 to the workflow controller 103 in natural language format. The workflow controller 103 sends the text of the email approval 207 to the natural language processor 104, which interprets the text to determine whether the user 100 has approved or declined the email approval request 206. The natural language processor 104 then sends its determination back to the workflow processor 103. If the user 100 approved email approval request 206, the workflow controller 103 sends a booking request 208 to the middleware software 105, which interfaces with travel service suppliers 106 to book and confirm the selected travel. The middleware software 105 records the booked travel and sends the user 100 a confirmation email 210 including itinerary and calendar information. Calendar entries for the confirmed itinerary will automatically be added to the user's 100 calendar within the user's 100 email service provider.

In the event that the natural language processor 104 cannot translate the text within a given email, the email will automatically forward to an agent 102. If the agent 102 is able to translate or interpret the text, then the ordinary searching or booking process may resume in the normal, automated format depicted in FIGS. 1 and 2. If the agent 102 is unable to translate the text, the agent 102 may email the user 100 to request clarification. Once clarification is received, then normal searching or booking procedures may resume, as depicted in the flow charts in FIGS. 1 and 2.

If changes to an itinerary need to be made, the user 100 may send an email to an agent 102 requesting a change. The agent 102 will then work directly with the user 100 to make any changes to the user's 100 itinerary.

The present invention achieves several advantages over the prior art. Because the entire searching and booking processes are accomplished through email, the user 100 is not required to exit from his normal work flow or framework and call a travel agent or open an Internet application in order to book his travel. This causes minimal disruption and therefore achieves a more unified and cohesive work experience for the user 100. The prior art at most communicates to travelers via email to send a confirmation of the traveler's itinerary, but does not allow searching and booking through email. Furthermore, some prior art will solicit travelers in the form of an email, and even allow travelers to enter in certain fields in the email, but will ultimately cause an internet application to open and redirect the traveler to complete the booking process over the internet rather than through the original email. The travel management platform of the present invention, in contrast, provides total communication and seamless and comprehensive travel management for the user 100 through email.

A further advantage of the present invention is that it is well-suited for companies that provide email applications to its employees but not internet access. Because the present invention enables the entire searching and booking process to be completed via email, the lack of internet access poses no barrier to an employee booking his own business travel. In contrast, internet travel websites would be unable to serve the business travel needs of a company that did not provide internet access to its employees.

What is claimed is:

1. A travel management platform for booking travel arrangements, comprising:
a workflow controller for sending and receiving email communications with a user and for managing a process for booking travel arrangements;
a natural language processor for receiving a natural language search query sent by the user to the workflow controller, and for interpreting the natural language search query into a translated search query; and
a middleware software program for receiving the translated search query, sending the translated search query to travel service suppliers, receiving travel products from the travel service suppliers that satisfy the translated search query, and sending the travel products to the workflow controller.
filtering the travel products based on the user's pre-specified preferences and needs and a company's travel rules and policies

2. A method for searching for travel arrangements via email, comprising the steps of:
sending an email search query to a workflow controller; interpreting the search query into a translated search query; submitting the translated search query to travel service suppliers;
receiving travel products from travel service suppliers that satisfy the translated search query;
sending the user an email of the travel products.

3. The method of claim 2, wherein the email search query is in natural language format.

4. The method of claim 2, wherein the email search query comprises a form into which the user enters search one or more search queries.

5. The method of claim 2, wherein after receiving travel products from travel service suppliers that satisfy the translated search query, and before sending the user an email of the travel products, the travel products are reviewed by an agent to confirm that they satisfy the translated search query.

6. A method for booking travel arrangements via email, comprising the steps of:
sending an email book request containing a user's desired travel arrangements to a workflow controller;
interpreting the email book request into a translated book request;
sending an email approval request containing the translated book request to the user;
sending an email response to the email approval request to the workflow controller;
interpreting the email response for approval or declination of the email approval request;
interfacing with travel service suppliers to book and confirm the translated book requests, if the email approval request is approved by the user;
sending an email the user containing an itinerary and calendar information;

7. The method of claim 6, wherein the email book request is in natural language format.

8. The method of claim 6, wherein the email book request comprises a form into which the user makes entries.

9. The method of claim 6, wherein after interpreting the email response for approval or declination of the email approval request, the translated book request must be approved by the users superior before interfacing with travel service suppliers to book and confirm the translated book requests.

10. A plug-in for the travel management platform of claim 1, consisting of means for booking travel arrangements such that the travel arrangements do not conflict with a users existing calendar engagements.

11. A plug-in for the travel management platform of claim 1, consisting of means for automatically notifying a user of a need to reschedule travel arrangements when calendar entries are made that conflict with existing travel arrangements.

12. A plug-in for the travel management platform of claim 1, consisting of means for booking travel arrangements through submitting travel needs directly through the user's calendar application when entering events into the user's calendar.
